(19) United States
(12) Patent Application Publication
(10) Pub. No.: US 2008/0219466 A1
(43) Pub. Date: Sep. 11, 2008

(54) Low bit-rate universal audio coder

(75) Inventors: Ramin Pishehvar, Ottawa (CA); Hossein Najaf-Zadeh, Stittsville (CA); Louis Thibault, Gatineau (CA)

Correspondence Address: FREEDMAN & ASSOCIATES, 117 CENTREPOINTE DRIVE, SUITE 350, NEPEAN, ONTARIO, K2G 5X3, CA

(73) Assignees: Her Majesty the Queen in Right of Canada, as represented by the Minister of Industry, through; the Communications Research Centre Canada, Ottawa (CA)

(21) Appl. No.: 12/073,660

(22) Filed: Mar. 7, 2008

Related U.S. Application Data
(60) Provisional application No. 60/905,848, filed on Mar. 9, 2007.

(51) Int. Cl. H04R 3/02

(52) U.S. Cl. 381/73.1

(57) ABSTRACT

A biologically-inspired process for universal audio coding based on neural spikes is presented. The process is based on the generation of sparse two-dimensional time-frequency representations of audio signals, called spikegrams. The spikegrams are generated by projecting the audio signal onto a set of over-complete adaptive gamma-chirp kernels. A masking model is applied to the spikegrams to remove inaudible spikes and to increase the coding efficiency. In respect of one aspect of the invention, the masked spikegram is then quantized using a genetic-algorithm-based quantizer (or its simplified linear version). The values are then differentially coded using graph based optimization and entropy coded afterwards.

This application claims benefit from U.S. Provisional Application No. 60/905,848 filed Mar. 9, 2007.

### FIELD OF THE INVENTION

The instant invention relates to audio communications and more particularly to a universal audio coder.

### BACKGROUND

Non-stationary and time-relative structures such as transients, timing relations among acoustic events, and harmonic periodicities provide important cues for different types of audio processing such as, for example, audio coding. Obtaining these cues is difficult since most signal representation/analysis techniques are block-based, i.e. the signal is processed piecewise in a series of discrete blocks. Transients and non-stationary periodicities in the signal are temporally smeared across blocks. Large changes in the representation of an acoustic event occur depending on the arbitrary alignment of the processing blocks with events in the signal.

Proper choice of signal analysis techniques such as windowing and the transform reduce these effects, but it would be beneficial if the signal representation is insensitive to signal shifts. Shift-invariance alone, however, is not a sufficient constraint on designing a general sound processing technique. Another important feature is coding efficiency, which is the ability of the signal representation to reduce the information redundancy from the raw time domain signal. A desirable signal representation captures the underlying 2D-time frequency structures such that they are directly observable and well represented at low bit rates.

Different state of the art coding techniques address these requirements, and typically fall into three classes: block-based coding; filter-bank based shift invariant coding; and over-complete shift invariant representations.

Block based coding is the most common form of signal representation used in audio coding, including but not limited to Discrete Cosine Transform (DCT), Modified Discrete Cosine Transform (MDCT) and Discrete Fourier Transform (DFT). In block-based coding techniques, the signal is processed piecewise in a series of discrete blocks, causing temporally smeared transients and non-stationary periodicities. While simple, the approaches result in large changes in the representation of an acoustic event depending on the arbitrary alignment of the processing blocks with events in the signal. Proper choice of signal analysis techniques such as windowing or the choice of the transform reduce these effects, but do not eliminate them, and it is preferable if the representation is insensitive to signal shifts.

In the filter-bank-based shift-invariant coding, the signal is continuously applied to the filters of the filter-bank and its convolution with the impulse responses is then determined. Therefore, the output signals of these filters are shift invariant, overcoming the drawbacks of the block-based coding mentioned above, such as time variance. However, an important aspect not taken into account is coding efficiency or, equivalently, the ability of the signal representation to capture underlying structures in the signal. A desirable signal representation reduces the information redundancy from the raw signal so that the underlying structures are directly observable. However, convolution based representations, such as filter-bank-based designs actually increase the dimensionality of the input signal.

In the over-complete shift-invariant representations, the number of basis vectors—kernels—is greater than the real dimensionality—number of non-zero eigenvalues in the covariance matrix—of the input signal. This technique matches the best kernels to different acoustic cues using different convergence criteria such as residual energy. However, the minimization of the energy of the residual—error—signal is not sufficient to get an over-complete representation of the input signal. Other constraints such as sparseness are considered in order to obtain a unique solution. Over-complete representations have been used because they are more robust in the presence of noise. In order to find the “best matching kernels”, typically a matching pursuit technique is employed.

It would be highly desirable to provide a shift-invariant signal representation that extracts acoustic events without smearing and with high coding efficiency.

### SUMMARY OF EMBODIMENTS OF THE INVENTION

In accordance with an aspect of the invention there is provided a method comprising:

receiving an audio signal;
iteratively determining a spikegram of the audio signal, the spikegram being a sparse two dimensional time-frequency representation of the audio signal;
masking the spikegram in dependence upon a masking model;
determining a coded audio signal by coding the masked spikegram; and,
providing the coded audio signal.

In accordance with an aspect of the invention there is further provided an audio coder comprising:

an input port for receiving an audio signal;
an electronic circuit connected to the input port for:
iteratively determining a spikegram of the audio signal, the spikegram being a sparse two dimensional time-frequency representation of the audio signal;
masking the spikegram in dependence upon a masking model; and,
determining a coded audio signal by coding the masked spikegram; and,
   an output port connected to the electronic circuit for providing the coded audio signal.

In accordance with an aspect of the invention there is yet further provided a storage medium having stored therein executable commands for execution on a processor, the processor when executing the commands performing:
receiving an audio signal;
iteratively determining a spikegram of the audio signal, the spikegram being a sparse two dimensional time-frequency representation of the audio signal;
masking the spikegram in dependence upon a masking model;
determining a coded audio signal by coding the masked spikegram; and,
providing the coded audio signal.

### BRIEF DESCRIPTION OF THE DRAWINGS

Exemplary embodiments of the invention will now be described in conjunction with the following drawings, in which:

FIG. 1 illustrates the samples of percussion sound employed in analyzing the performance of an embodiment of the invention;

FIG. 2 illustrates a spikegram of the percussion signal using an exemplary embodiment of the invention with a gammatone matching pursuit algorithm according to an embodiment of the invention;

FIG. 3 illustrates a comparison of exemplary adaptive and non-adaptive spike coding embodiments of the invention applied to the percussion signal of FIG. 1;

FIG. 4 illustrates a comparison of exemplary adaptive and non-adaptive spike coding embodiments of the invention applied to a speech signal;

FIG. 5 illustrates a comparison of exemplary adaptive and non-adaptive spike coding embodiments of the invention applied to a speech signal with 16 channels;

FIG. 6 illustrates the convergence rate for exemplary adaptive and non-adaptive spike coding embodiments of the invention applied to white noise;

FIG. 7 illustrates the minimum point of a cost function used in an embodiment of the invention;

FIG. 8 illustrates the optimal quantization levels qᵢ for four different types of audio signals used in an embodiment of the invention;

FIG. 9 illustrates a comparison of the performance of the in-loop quantizer with the out-of-loop quantizer for castanet;

FIG. 10 illustrates the power spectrum of a frame of an audio signal and also the spectra for the residual for the matching pursuit and the perceptual matching pursuit process of an embodiment of the invention;

FIG. 11 illustrates a simplified flow diagram of an embodiment of a method of coding an audio signal according to the invention; and,

FIG. 12 illustrates a simplified block diagram of an embodiment of an audio coder according to the invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

In the description hereinbelow and in the claims mathematical terms such as maximum, minimum, best, etc. are used for clarity, but as is evident to one skilled in the art these terms are not be considered as being strictly absolute but also include degrees of approximation depending, for example, on the application or technology.

The embodiments of the invention presented hereinbelow provide an auditory sparse and over-complete representation of an audio signal suitable for audio coding by: iteratively generating a spike based representation—spikegram—of the audio signal; masking the spike based representation to increase coding efficiency; and coding the resulting masked spike based representation.

In generating the spike based representation, the audio signal is decomposed into its constituent parts—kernels—using, for example, a matching pursuit process. This process employs, for example, gammatone/gammachirp filter-banks for the projection basis, but is not limited thereto. By employing asymmetric kernels such as gammatone/gammachirp kernels, the process does not create pre-echoes at onset events. However, very asymmetric kernels such as damped sinusoids are not able to model harmonic signals. The employment of the gammatone/gammachirp kernels provides additional parameters that control attack and decay parts—degree of symmetry—of the asymmetric kernels of the decomposed audio signal, which are modified in dependence upon the audio signal as will be shown hereinbelow.

The spike based representation of the audio signal is determined using an iterative process which is implemented as a non-adaptive iterative process or an adaptive iterative process.

In mathematical notations, the audio signal x(t) is decomposed into the over-complete kernels as follows

$$x ( t ) = {\sum }_{m = 1}^{M} {\sum }_{i = 1}^{{n}_{m}} {a}_{i}^{m} {g}_{m} ( t - {τ}_{i}^{m} ) + ∈ ( t ) \qquad ( 1 )$$

where τ^{m}ᵢ and a^{m}ᵢ are the temporal position and amplitude of the i th instance of the kernel gₘ, respectively. The notation nm indicates the number of instances of gₘ, which need not be the same across kernels. In addition, the kernels are not restricted in form or length. In order to find adequate values for τ^{m}ᵢ, a^{m}ᵢ, and gₘ with the matching pursuit process, the audio signal x(t) is decomposed over a set of kernels to capture the structure of the signal. The audio signal is iteratively approximated with successive orthogonal projections onto a basis. The audio signal is then decomposed into

x(t)=<x(t),gₘ>gₘ+Rₓ(t) (2)

where <x(t), gₘ> is the inner product between the audio signal and the kernel and is equivalent to a^{m} in Eq. 1. Rₓ(t) is the residual signal.

In the non-adaptive process gammatone filters are employed. The impulse response, g (f_{c}, t), of a gammatone filter is given as

g(f_{c},t)=(t)³e^{-2πbt} cos(2πf_{c}t)t>0, (3)

where f_{c} is the center frequency of the filter, distributed on Equal Rectangular Bandwidth (ERB). At each iteration step the audio signal is projected onto the gammatone kernels with different center frequencies and different time delays. The center frequency and time delay that give the maximum projection are then chosen and a spike with the value of the projection is added to the “auditory representation” at the corresponding center frequency and time delay. During the iterative process the residual signal, Rx(t), decreases.

The adaptive iterative process takes account of not only the additional parameters controlling the gammachirp kernels, but also of the inherent nonlinearity of the auditory pathway. In the adaptive iterative process, for example, gammachirp kernels are employed. Optionally, other adaptive basis functions are employed. The impulse response of gammachirp kernels, having additional tuning parameters b, l, and c, is given below as

g(f_{c}t,b,l,c)=t^{l-1}e^{-2πtb} cos(2πf_{c}t+clnt)t>0. (4)

It has been shown that the gammachirp kernels minimize the scale/time uncertainty, as taught in Irino et al “A compressive gammachirp auditory filter for both physiological and psychophysical data” (JASA, 109(5):2008-2022, 2001). In embodiments of the invention the chirp factors c, l, and b are determined adaptively at each iteration step. The chirp factor c enables modification of the instantaneous frequency of the kernels, while chirp factors l and b control the attack and the decay of the kernels respectively. Alternatively, other kernels comprising tuning parameters are employed.

As is evident, there are numerous search techniques available for determining the three chirp parameters. Given the large parameter space most search techniques are computationally very complex.

Therefore, in respect of embodiments of the invention search techniques that are suboptimal but computationally less complex are employed such as, for example, one described in Gribonval “Fast matching pursuit with a multiscale dictionary of Gaussian chirps” (IEEE Trans. Signal Processing, 49(5):994-1001, 2001), but are not limited thereto.

According to one embodiment of the invention the suboptimal search technique employs the same gammatone filters as the ones used in the non-adaptive process above and uses values for the l and b chirp parameters equal to those disclosed by Irino et al “A compressive gammachirp auditory filter for both physiological and psychophysical data” (JASA, 109(5):2008-2022, 2001). This step provides the center frequency and start time (t0) of the best gammatone matching filter, as defined by Eq. 5. Within the iterative process the second best frequency—gammatone kernel—and start time are also stored, as defined by Eq. 6 below.

$$\begin{matrix}{G}_{max 1} = {{arg max}_{g ∈ G}}_{f , {t}_{0}} \{ \vert r - g ( f , {t}_{0} , b , l , c ) \vert \} & ( 5 ) \\ {G}_{max 2} = {arg {max}_{f , {t}_{0}}}_{g ∈ G - {G}_{max 1 ,}} \{ \vert r - g ( f , {t}_{0} , b , l , c ) \vert \} & ( 6 )\end{matrix}$$

In Eqs. 5 and 6, G is the set of all kernels, and G−Gmax1 excludes Gmax1 from the search space. For the sake of simplicity in nomenclature “f” is used instead of “f_{c}” in Eqs. 5 through 9. The information extracted in the first step is then utilized to find the chirp factor “c”. In other words, only the set of the best two kernels are stored in step one, and utilized to find the best chirp factor given Gmax1 and Gmax2 as defined in Eq. 7 below.

$${G}_{max c} = {arg {max}_{c}}_{g ∈ {G}_{max 1} ⋃ {G}_{max 2.}} \{ \vert r - g ( f , {t}_{0} , b , l , c ) \vert \} \qquad ( 7 )$$

The information extracted in the second step is then used to find the best “b”, according to Eq. 8 below, and the best “1” among Gmaxb found in this previous step according to Eq. 9 below.

$$\begin{matrix}{G}_{max b} = {arg {max}_{b}}_{g ∈ {G}_{max c}} \{ \vert r - g ( f , {t}_{0} , b , l , c ) \vert \} & ( 8 ) \\ {G}_{max l} = {arg {max}_{l}}_{g ∈ {G}_{max b}} \{ \vert r - g ( f , {t}_{0} , b , l , c ) \vert \} & ( 9 )\end{matrix}$$

As a result of this sequence of steps six parameters are extracted in the adaptive technique for the “auditory representation”; these being the center frequencies, chirp factors “c”, time delays, and spike amplitudes, “b”, and “l”. As discussed previously these parameters determine the spike amplitudes; the attack; and the decay slopes of the kernels. Although, there are additional parameters in this second process, as will be shown hereinbelow the adaptive technique provides enhanced coding gains. This arises as a smaller number of filters—in the filter-bank—and a smaller number of iterations are used to achieve the same Signal-Noise Ratio (SNR), which is indicative of the of the audio signal.

In order to increase the coding efficiency, according to an embodiment of the invention the number of spikes in the spike based representation of the audio signal is reduced by removing inaudible spikes using a masking model. For the sake of simplicity, the description of the masking model hereinbelow is limited to gammatone functions but, as will become apparent to those skilled in the art, is also applicable using gammachirp functions. Optionally, other masking models are adapted for removing inaudible spikes.

For on-frequency temporal masking, i.e. the temporal masking effects in each critical band (channel), the process to calculate the temporal forward and backward masking comprises the following steps. First the absolute threshold of hearing in each critical band is calculated

QTₖ=ATₖ+10{log 10(200)−log 10(dₖ)} (10)

where ATₖ is the absolute threshold of hearing for critical band k, QTₖ is the elevated threshold in quiet for the same critical band, and dₖ is the effective duration of the k th basis function defined as the time interval between the points on the temporal envelope of the gammatone function where the amplitude drops by 90%. Since the basis functions are short, the absolute threshold of hearing is elevated by 10 dB/decade when the duration of basis function is less than 200 msec.

The masker sensation level is given by

$${SL}_{k} ( i ) = 10 log ( \frac{{a}_{k}^{2} {A}_{k}^{2}}{{QT}_{k}} ) \qquad ( 11 )$$

where SLₖ(i) is the sensation level of the i th spike in critical band k, aₖ(i) is the amplitude of the i th spike in the critical band k, and Aₖ is the peak value of the Fourier transform of the normalized gammatone function in the critical band k. When a maskee starts within the effective duration of the masker, the masking threshold is given by

Mₖ(nᵢ:nᵢ+Lₖ)=max(Mₖ(nᵢ:nᵢ+Lₖ),SLₖ(i)−20) (12)

where Mₖ is the masking pattern (in dB) in the critical band k, nᵢ is the start time index of the i th spike, and Lₖ is the effective length of the gammatone function in the critical band k as defined by the effective duration dₖ of the gammatone function in the critical band k multiplied by the sampling frequency.

Since gammatone functions are tonal-like signals, it is considered that the masking level caused by a spike is 20 dB less than its sensation level. In order to avoid over-masking the spikes, the process takes the maximum of the masking threshold due to a spike and the threshold caused by other spikes in the same critical band at any time instance. Alternative situations are when a maskee starts after the effective duration of the masker (i.e., forward masking), and when a maskee starts before a masker (i.e., backward masking). For forward and backward masking, a linear relation between the masking threshold (in dB) and the logarithm of the time delay between the masker and the maskee in milliseconds is assumed, as taught, for example, in Jesteadt et al “Forward masking as a function of frequency, masker level, and signal delay” (JASA, pages 950-962, 1982), but not limited thereto.

Since the effective duration of forward masking depends on the masker duration, an effective duration for forward masking in the critical band k is defined as follows

Fdₖ=100 arc tan(dₖ) (13)

The forward masking threshold is given by

$${FM}_{i} ( n ) = ( SL ( i ) - 20 ) \frac{{log}_{10} ( \frac{n}{{n}_{i} + {L}_{k} + {FL}_{k}} )}{{log}_{10} ( \frac{{n}_{i} + {L}_{k} + 1}{{n}_{i} + {L}_{k} + {FL}_{k}} )} \qquad ( 14 )$$

where nᵢ+Lₖ+1≦n≦nᵢ+Lₖ+FLₖ and

FLₖ=round(Fdₖ·fₛ) (15)

where fₛ denotes the sampling frequency. The index i denotes the index of the spike and k is the channel number. This forward masking contributes to the global masking pattern in the critical band k as follows

Mₖ(nᵢ+Lₖ+1:nᵢ+Lₖ+FLₖ)=max(nᵢ+Lₖ+1:nᵢ+Lₖ+FLₖ,FMᵢ) (16)

For the backward masking, 5 msec are taken as the effective duration of masking for all critical bands regardless of the effective duration of the gammatone functions. Hence, the backward masking threshold is given by

$${BM}_{i} ( n ) = ( SL ( i ) - 20 ) \frac{{log}_{10} ( \frac{n}{{n}_{i} - 0.005 {f}_{a}} )}{{log}_{10} ( \frac{{n}_{i} - 1}{{n}_{i} - 0.005 {f}_{a}} )} . \qquad ( 17 )$$

Similar to the forward masking, the backward masking affects the global masking pattern in the critical band k as follows

Mₖ(nᵢ−0.005fs:nᵢ−1)=max(Mₖ(nᵢ−0.005fs:nᵢ−1),BMᵢ) (18)

Off-frequency masking effects, i.e. the masking effects of a masker on a maskee that is in a different channel, are addressed by considering the masking effects caused by any spike in two adjacent critical bands. According to Terhardt et al “Algorithm for extraction of pitch and pitch salience from complex tonal signals” (JASA, pages 679-688, 1982) a single masker produces an asymmetric linear masking pattern in the Bark domain, with a slope of −27 dB/Bark for the lower frequency side and a level-dependent slope for the upper frequency side. The slope for the upper frequency side is given by

$${s}_{u} = - 24 - \frac{230}{f} + 0.2 L \qquad ( 19 )$$

where f=fc is the masker frequency, i.e. the gammatone center frequency, in Hertz and L is the masker level in dB. Performing this analysis to calculate the masking effects caused by each spike in the two immediate neighboring critical bands indicates the need for an effective masking model for off-frequency masking in spike coding.

While masking models are known, and employed in most audio coding systems, such as MPEG-1 Audio Layer 3 (MP3) and Advanced Audio Coding (AAC), analysis has shown that these do not perform well in spike coding. This arises as spikes are well localized in both time and frequency and removing any audible spike produces musical noise that is not tolerable in high quality audio coding.

As noted above, sparse codes generate peaky histograms suitable for entropy coding. Therefore, according to an embodiment of the invention arithmetic coding is used to allocate bits to these quantities. Time-differential coding is then employed within this embodiment to further reduce the bit rate. Optionally, other differential coding techniques such as the Minimum Spanning Tree (MST) are employed.

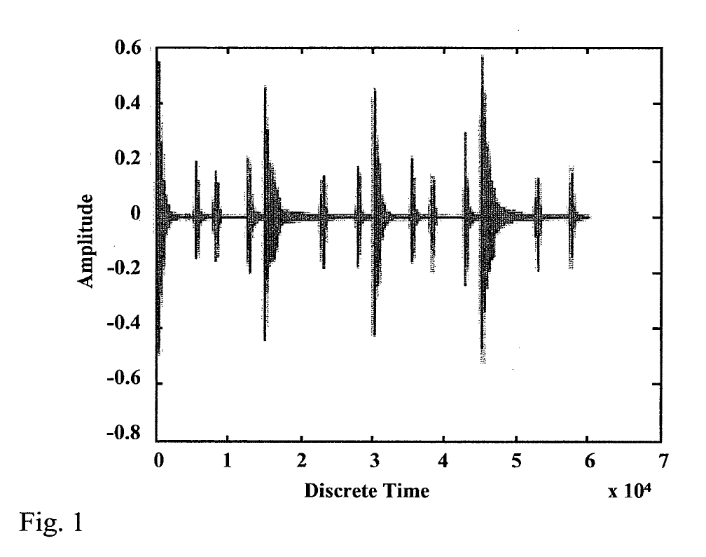

In order to demonstrate the process of spikegrams generation, masking and coding, four different sounds—percussion, speech, castanet, and white noise—are processed according to an embodiment of the invention and the results presented with reference to FIGS. 1 to 6.

Referring to FIG. 1, the audio signal for the percussion sound employed in the analysis is shown. The audio signal shows a very sharp attack and quick decay. Two embodiments of the invention, adaptive and non-adaptive iteration, were employed.

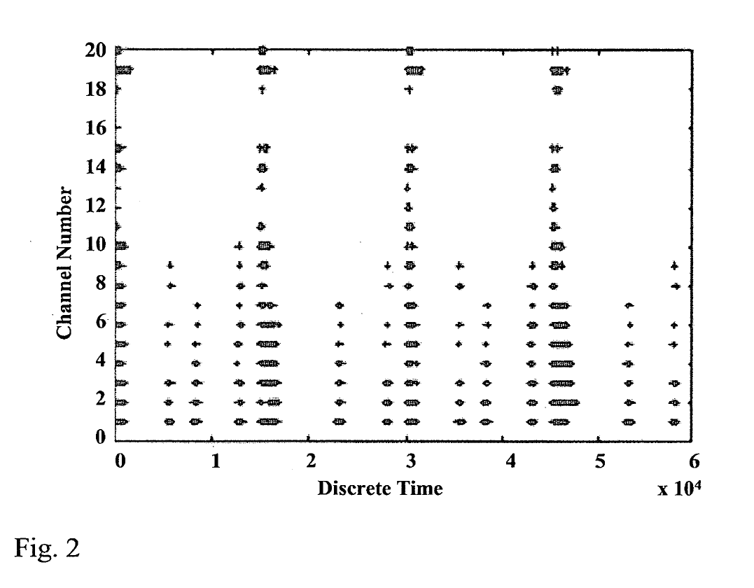

In the embodiment employing the non-adaptive iterative process, the matching pursuit process was run for 30000 iterations to generate 30000 spikes, and the resulting spikegram is shown in FIG. 2. Referring to FIG. 2, the onsets and offsets of the percussion are clearly detected. There are 30000 spikes in the spikegram, generated from 80000 samples of the original sound file, before temporal masking is applied. Each dot represents the time and the channel where the spike fired, as extracted by the matching pursuit process. No spike is extracted between channels 21 and 24. Applying the above masking technique results in the number of spikes after temporal masking being 29370. The spike coding gain in this case was 0.37N, where N is the number of samples in the original signal.

Two parameters are important for each spike: its position or spiking time and its amplitude. A lossless compression was used to encode these two parameters. First the histogram of the values was extracted, and thereafter arithmetic coding was used for compressing these values. For spike timing a differential process was employed, wherein time instances of spikes are first sorted in increasing order, and only the time elapsed since the last sorted spike is stored. This reduces the dynamic range of spike timings and makes it possible to perform arithmetic coding on timing information as well as for the compression of center frequencies. Accordingly 135330 bits were used to code the spiking amplitudes and 51930 bits to code the timing information. For center frequencies, 45440 bits were used. This process provided a total bit rate of 1.93 bits/sample.

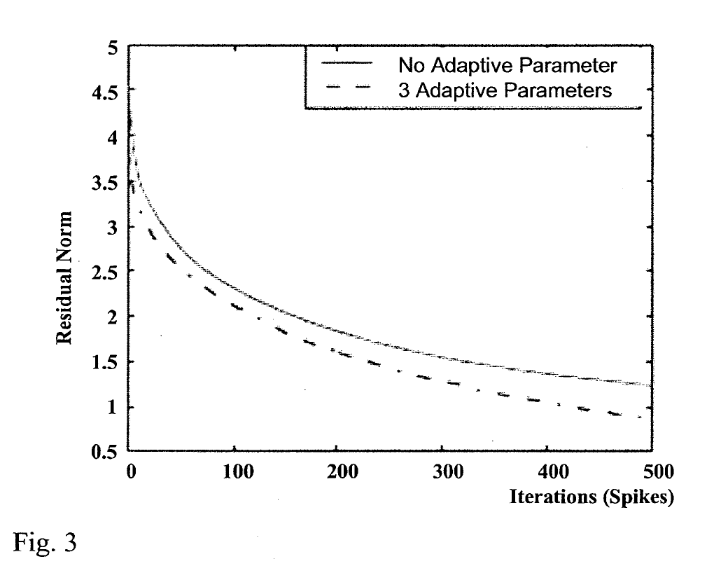

In the embodiment employing the adaptive iterative process the gammachirp filters are used as described in the previous section, and FIG. 3 shows the decrease of residual error through the number of iterations for the adaptive and non-adaptive approaches. Table 1 illustrates comparative results for the coding of percussion (80000 samples) at high quality scores above 4 on the ITU-R 5-grade impairment scale in informal listening tests for the adaptive and the non-adaptive iterative process.

Further, Table 1 summarizes the results and provides a comparison of the two embodiments. The number of spikes for the non-adaptive iteration before masking for the same residual energy is 44% percent more than the number of spikes for the adaptive iteration. The resulting spike gain is 0.12N.

TABLE 1

| | Adaptive | Non-Adaptive |
|---|---|---|
| | (24 Channels) | (24 Channels) |
| Spikes before masking | 10000 | 24000 |
| Spikes after masking | 9430 | 29370 |
| Spike gain | 0.12N | 0.37N |
| Bits for channel coding | 30620 | 45440 |
| Bits for amplitude coding | 37430 | 135350 |
| Bits for time coding | 30250 | 51390 |
| Bits for chirp factor coding | 9940 | 0 |
| Bits for coding b | 21350 | 0 |
| Bits for coding l | 25500 | 0 |
| Total bits | 155090 | 232720 |
| Bit rate (bit/sample) | 1.93 | 2.90 |

The same two processes, adaptive and non-adaptive, were then applied to speech coding, wherein the speech signal used was the utterance “I'll willingly marry Marylin”.

In the non-adaptive process the spikegram contains 56000 spikes before temporal masking. The number of spikes was reduced to 35208 after masking, giving a spike coding gain of 0.44N. Arithmetic coding to compress spike amplitudes and differential timing (time elapsed between consecutive spikes) was employed. The overall coding rate is 3.07 bits/sample.

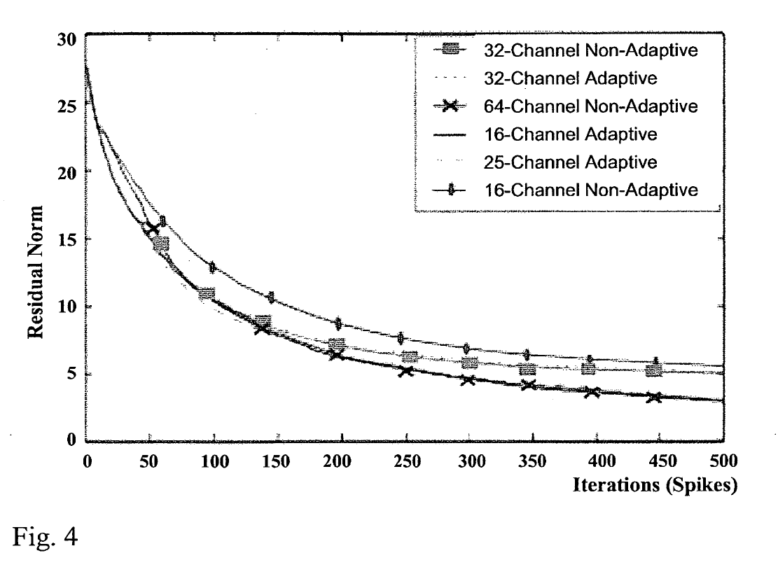

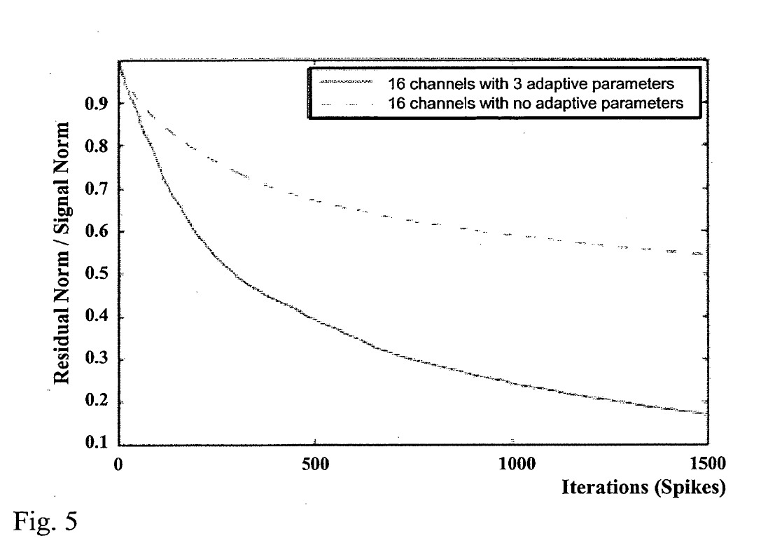

Referring to FIGS. 4 and 5, results in the case of speech using the adaptive process show that the embodiments reduce both the number of spikes and the number of cochlear channels (filter-bank channels) substantially. To achieve the same quality, 12000 spikes are used compared to 56000 spikes for the non-adaptive process. The number of spikes after masking is 10492 spikes, giving a spike coding gain of 0.13N, compared to 0.44N in the non-adaptive process. The overall required bit rate is 1.98 bits/sample, which is approximately 35 percent lower than in the non-adaptive process.

Table 2 illustrates comparative results for the coding of speech (80000 samples) at high quality scores above 4 on the ITU-R 5-grade impairment scale in informal listening tests for the adaptive and the non-adaptive iterative process.

TABLE 2

| | Adaptive | Non-Adaptive |
|---|---|---|
| | (24 Channels) | (24 Channels) |
| Spikes before masking | 12000 | 56000 |
| Spikes after masking | 10492 | 35208 |
| Spike gain | 0.13N | 0.44N |
| Bits for channel coding | 40960 | 118536 |
| Bits for amplitude coding | 35432 | 67048 |
| Bits for time coding | 40190 | 60376 |
| Bits for chirp factor coding | 9836 | 0 |
| Bits for coding b | 15260 | 0 |
| Bits for coding l | 16000 | 0 |
| Total bits | 157676 | 245960 |
| Bit rate (bit/sample) | 1.98 | 3.07 |

In the case of coding castanet, the adaptive coding process was utilized and obtained an ITU-R impairment scale score of 4 in informal listening tests. The number of spikes before temporal masking was 7000, temporal masking reduced the number of spikes to 6510. Overall spike coding gain was 0.08N in the adaptive process and 0.30N in the non-adaptive process with bit rates of 1.54 bits/sample and 3.03 bits/sample, respectively.

Table 3 illustrates comparative results for the coding of castanet (80000 samples) at high quality scores above 4 on the ITU-R 5-grade impairment scale in informal listening tests for the adaptive and the non-adaptive iterative process.

TABLE 3

| | Adaptive | Non-Adaptive |
|---|---|---|
| | (24 Channels) | (24 Channels) |
| Spikes before masking | 7000 | 30000 |
| Spikes after masking | 6510 | 24580 |
| Spike gain | 0.08N | 0.30N |
| Bits for channel coding | 22930 | 85000 |
| Bits for amplitude coding | 39450 | 83810 |
| Bits for time coding | 33000 | 73540 |
| Bits for chirp factor coding | 7780 | 0 |
| Bits for coding b | 13900 | 0 |
| Bits for coding l | 6510 | 0 |
| Total bits | 123570 | 242350 |
| Bit rate (bit/sample) | 1.54 | 3.03 |

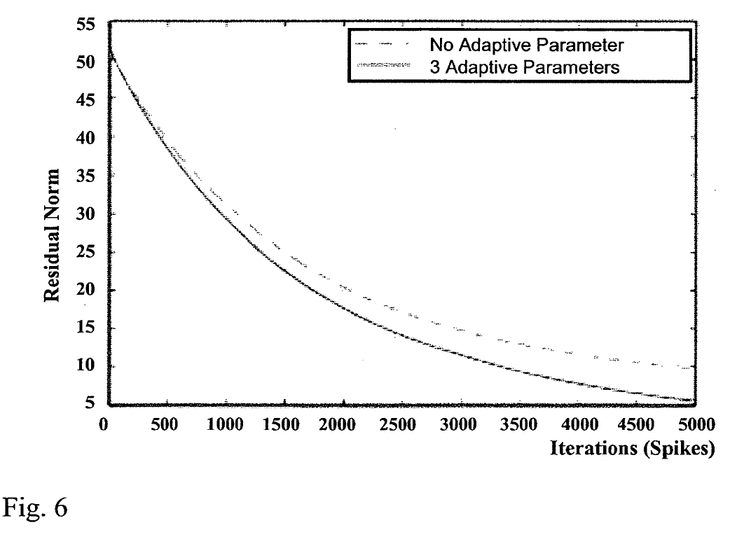

Finally, the adaptive and non-adaptive processes were executed using white noise as the source audio signal and the results compared. These results are shown in FIG. 6, and as for other signal types, the adaptive process outperforms the non-adaptive one. Further, unlike other coding processes the process according to an embodiment of the invention is able to model stochastic white noise.

Using the adaptive process according to an embodiment of the invention spike gains ranging from 0.08N to 0.13N were achieved for four different sound classes that represent typical limits of audio signals to be coded.

The embodiments according to the invention described above employed the matching pursuit process, which although efficient is relatively slow. Optionally, other processes are employed such as, for example, a novel closed-form formula for the correlation between gammatone and gammachirp filters. Further optionally, performance improvements are achieved by introducing perceptual criteria or employing a weak/weighted matching pursuit process. In respect of coding, the embodiments disclosed above employ time differential coding to code spikes. Optionally, the dynamics of the time evolution of spike amplitudes, channel frequencies, etc. are employed to provide information for improving the coding process. Further optionally, the spikes are considered graph nodes and optimization based upon coding cost through different paths is performed.

In the embodiments according to the invention described above each spike is encoded as a separate entity. To reduce the final coding bit rate, according to an embodiment of the invention only the differences between parameters associated with spikes are encoded using graph-based optimization. Optionally, other optimization techniques are employed. Each of the spikes generated by the matching pursuit process represents a node in the graph. The coding cost—the number of bits needed to go from one node to another—is then associated to the edge connecting each two nodes of the graph. The differential coding process is applied to all parameters, thus allowing omission of node index information reducing the overall bit rate. The graph optimization is performed using two different processes: minimum spanning tree and traveling salesman problem. In the first process a spanning tree that minimizes the total graph cost function, i.e. minimizes the total number of bits used to differentially encode all nodes/spikes in the graph, is determined. The differential values are then entropy coded using a variable length encoder such as, for example, an arithmetic coder.

It has been observed that minimizing the total graph cost function based on only differential bit costs produces in some situations a flat histogram of values resulting in poor entropy gain when arithmetic coding is applied. This problem is overcome by modifying the optimization cost function to also take into account the entropy of the global code generated by the graph. Therefore, the optimization cost function is modified as a global—over all spikes—cost function. To find the optimal path for the modified cost function simulated annealing is used, which is a trade-off between differential bit cost and entropy. Optionally, other processes than simulated annealing are employed provided that these processes do not perform a local search.

Simulation results have shown that the graph based coding is capable to reduce the bit rate by half for various audio signals compared to the coding applied in the embodiments according to the invention above. Introduction of the entropy trade-off provides an additional reduction of approximately 10%.

The cost function in the embodiments according to the invention described above is expressed as a trade-off between the quality of reconstruction and the number of bits used to code each modulus. More precisely, given the vector of quantization levels (codebook) q, the bit rate R, and the distortion D, the cost function to optimize is given by:

$$\begin{matrix}\begin{matrix}\hat{E} ( q ) = D + λ R \\ = \frac{‖ {\sum }_{i} {\hat{α}}_{i} {g}_{i} - {\sum }_{i} {α}_{i} {g}_{i} ‖}{{‖ {\sum }_{i} {a}_{i} {g}_{i} + η ‖}^{γ}} + λ H ( \hat{a} ) .\end{matrix} & ( 20 )\end{matrix}$$

For example, η=10⁻⁵ and γ=0.001 are set empirically. The weighting in the denominator of D allows a better reconstruction of the low-energy portion of the audio signal. The entropy is determined using the absolute values of the spike amplitudes. The vector of quantized amplitudes, \hat{α}, is determined as follows:

\hat{α}ᵢ=qᵢ for qᵢ₋₁<αᵢ<qᵢ (21)

H(\hat{α}) is the per spike entropy in bits used to encode the information content of each element of \hat{α} defined as:

$$H ( \hat{α} ) = - {\sum }_{i} {p}_{i} ( {\hat{α}}_{i} ) {log}_{2} {p}_{i} ( {\hat{α}}_{i} ) , \qquad ( 22 )$$

where pᵢ(\hat{α}ᵢ) is the probability of finding \hat{α}ᵢ. To perform the optimization at a given number of quantization levels, the initial values—initial population—for the qᵢ are randomly or pseudo randomly set and a Genetic Algorithm (GA) is used to determine an optimal solution according to an embodiment of the invention.

The GA is a search technique for finding true or approximate solutions to optimization and search problems. It is categorized as a global heuristic search. It is also a particular class of evolutionary processes that use techniques inspired by evolutionary biology such as inheritance, mutation, selection, and cross-over. The evolution usually starts from a population of randomly generated individuals and takes place in generations. In each generation, the fitness of every individual in the population is evaluated. Multiple individuals are then stochastically selected from the current population—based on their fitness—and modified to form a new population at each iteration. The new population is then used in the next iteration of the GA. The GA is implemented as a computer simulation in which a population of chromosomes of candidate solutions—called individuals—to an optimization problem evolves toward better solutions.

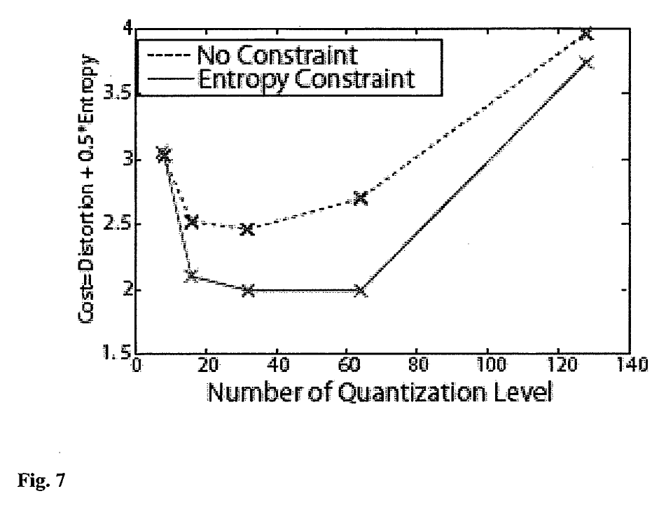

FIG. 7 illustrates the minimum point of the cost function—as defined in equation (20) obtained by the GA versus different numbers of quantization levels for both the entropy constrained and non constrained cases for speech. The entropy constrained case provides better results than the non constrained case. In addition, according to FIG. 7 the optimal number of quantization levels lies between 32 and 64.

For each of four different audio signal types—percussion, harpsichord, castanet, and speech—the optimization based on the GA as described above was performed and the optimal codebook determined. The analysis/synthesis gammachirp matching pursuit was applied and spikes were determined. Each spike amplitude was then quantized according to the optimal codebook. An objective perceptual quality evaluation was used to assess the quality of the reconstructed signal after quantization compared to the reconstructed signal without quantization. Table 4 shows that near transparent quality—PEAQ score between 0 and −1—is obtained for all audio signal types and both numbers of quantization levels. The bit rate is obtained by applying arithmetic coding to the quantized spike amplitudes. The arithmetic coding is applied to longer blocks—1 second—than the block size used for determining entropy in the cost function, in order to increase the bit rate gain. It is noted that the GA is applied to the absolute value of the spikes and the sign bit is sent separately.

TABLE 4

| | |
|---|---|
| 32 Levels | 64 Levels |

| | PEAQ | Bits/spike | PEAQ | Bits/spike |
|---|---|---|---|---|
| Percussion | −0.04 | 1.48 | −0.10 | 2.74 |
| Castanet | −0.70 | 2.27 | −0.33 | 2.84 |
| Harpsichord | −0.90 | 1.56 | −0.09 | 2.34 |
| Speech | −0.32 | 2.15 | −0.14 | 2.73 |

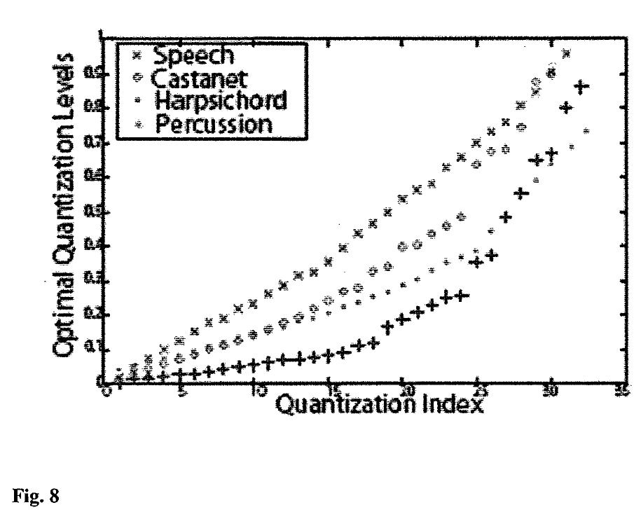

Performing the GA for each audio signal is a time consuming task. In addition, sending a new codebook for each audio signal type and/or frame results in an overhead we want to avoid. Therefore, according to another embodiment of the invention a piecewise linear approximation of the codebook is performed by using the histogram of the spikes. FIG. 8 shows the optimal quantization levels qᵢ for four different types of audio signals. The optimal solution is obtained using the GA process described above.

The optimal levels are approximated as piecewise linear segments. The method according to an embodiment of the invention to determine the piecewise linear quantizer is as follows:
determine the histogram, h, of the spike amplitudes, for example, a 40-bin histogram;
apply a threshold to the histogram using the sign function such that h(t)=sign(h) and smoothing the curves by applying a moving average filter, for example, with the impulse response

$$m ( n ) = {\sum }_{k} 0.125 δ ( n - k )$$

or k=1, 2 . . . , 8; and,
set a crossing threshold, for example, of 0.4—determined empirically—on the smoothed curve and each time the crosses the threshold define a new linear—uniform—quantizer—the two last threshold crossings.

The piecewise linear quantization has been applied for the above four different audio signal types. The 32 level quantizer provided near transparent coding results—PEAQ score between 0 and −1—only for two audio signals, as shown in Table 5. However, the quality is near transparent for all the audio signals when 64 levels are used due to the fact that the 64 level quantizer has more linear quantization levels—more linear quantization conversion functions—than the 32 level quantizer.

TABLE 5

PEAQ

| | 32-Levels | 64 Levels |
|---|---|---|
| Percussion | −1.30 | −0.25 |
| Castanet | −0.50 | −0.10 |
| Harpsichord | −1.10 | −0.15 |
| Speech | −0.95 | −0.44 |

In the embodiments of the invention described above the matching pursuit is performed on un-quantized spike amplitudes and the un-quantized values are stored in a vector. These un-quantized values are then quantized according to the optimal codebook determined using the GA process or the piecewise linear quantizer. This process is called out-of-loop quantization. Alternatively, according to an embodiment of the invention in-loop quantization is applied which performs two passes of matching pursuit. During the first pass, the matching pursuit is applied to the original audio signal and the optimal quantization values are determined—using, for example, GA or piecewise linear approximation. The matching pursuit is then performed a second time and the spike amplitudes are then quantized at each iteration before determining the residual Rᵢ by using the codebook determined in the first pass:

Rᵢ=\hat{α}ᵢgᵢ+Rᵢ₊₁. (23)

where \hat{α}ᵢ are quantized spikes.

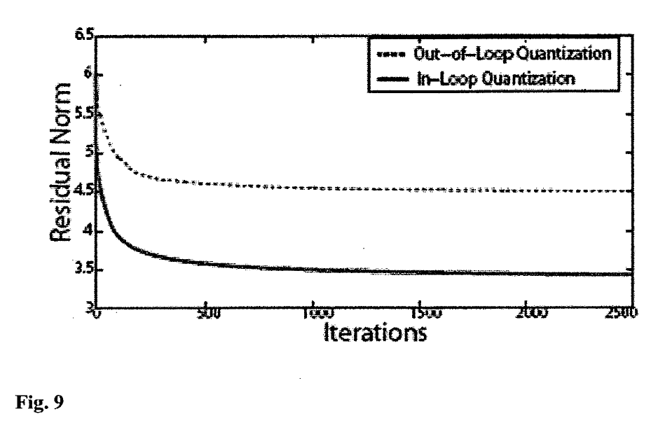

FIG. 9 illustrates a comparison of the performance of the in-loop quantizer with the out-of-loop quantizer for castanet. The in-loop quantization offers better performance but at a greater computational cost.

According to another embodiment of the invention an auditory masking model has been integrated into the matching pursuit process to account for characteristics of the human hearing system. The perceptual matching pursuit process creates a Time Frequency (TF) masking pattern to determine a masking threshold at all time indexes and frequencies. Once no kernel with magnitude above the masking threshold is determined, the decomposition stops and the audio signal is reconstructed using the determined kernels. The quality of the reconstructed audio signal depends on the accuracy of the masking model.

For forward and backward masking a linear relation between the masking threshold—in dB—and the logarithm of the time delay—in msec—between the masker and the maskee is assumed. Since the effective duration of forward masking depends on the masker duration, an effective duration for forward masking in critical band k follows Fdₖ=100 arctan(dₖ). The forward masking threshold is given by

$${FM}_{i} ( n ) = ( SL ( i ) - {c}_{kn} ) ( \frac{{log}_{10} ( \frac{n}{{n}_{i} + {L}_{k} + {FL}_{k}} )}{{log}_{10} ( \frac{{n}_{i} + {L}_{k} + 1}{{n}_{i} + {L}_{k} + {FL}_{k}} )} )$$

where SLₖ(i)—in dB—is the sensation level of the i th kernel in the critical band k, FLₖ=round (Fdₖfₛ), fₛ denotes the sampling frequency, nᵢ+Lₖ+1≦n≦nᵢ+Lₖ+FLₖ, and cₖₙ—in dB—is an offset value in the critical band k and time index n, subtracted from the sensation level to determine the masking threshold. Experiments have shown that for a strongly tonal portion of the spectrum this offset is approximately 20 dB. However, for noise like portions of the spectrum this offset is reduced to elevate the masking threshold. The following offset has been empirically determined as a function of the tonality level in each critical band for the frames of 1024 audio samples:

cₖₙ=4τₖₙ+16,

where τₖₙ is the tonality index for the critical band k at time index n. Values for the tonality index are between 0—for noise type signals—and 1—for a pure sinusoid.

It is known from psychoacoustic experiments that noise like and tonal maskers having same power produce different masking thresholds. The effectiveness of a noise masker exceeds that of a tonal masker by up to 20 dB. Therefore, the masking offset value is adapted to the characteristic of the audio signals in different critical bands. For many sounds such as speech a strong tonal structure is found in the low frequency portion of the spectrum, while no tonal behavior is observed at high frequencies. Therefore, the masking pattern has been made adaptive to the local behavior of the spectrum in each critical band. There are numerous methods available for identifying a tonal structure in an audio spectrum. In steady state portions of an audio signal, identification of tonal tracks—through inter frame sinusoidal track continuity—is the most accurate method. However, this method fails to identify short tones of 10-20 msec duration. Hence in order to avoid missing tonal behavior, a peak picking method has been applied on a spectrum representing 1024 audio samples—23.2 msec at 44100 Hz sampling rate.

The tonality level in each critical band in a frame of 1024 samples is determined. A frame of the audio signal is multiplied with a Hanning window, followed by a DFT of 1024 points. The first 512 components are grouped into 25 critical bands. The peaks in the spectrum are determined and associated with the corresponding critical band. If there is no spectral peak found in a critical band, its tonality index is set to zero. For a peak in a critical band the peak value and the higher magnitude from the two adjacent frequency bins are taken. The peak value and the magnitude in the adjacent frequency bin are assumed to be produced by a sinusoid. To verify this assumption, these values are compared with the normalized spectrum of a pure sinusoid windowed using a Hanning window. The peak value and the values in adjacent frequency bins of the assumed spectrum fit a second order polynomial in the log domain. The coefficients for the prototype second order polynomial are Cₚ_{²}=[−6.0206 0 0]. Using this polynomial fit, the position and maximum magnitude in the audio spectrum is determined as follows:

Aₘₐₓ=Aₚ−Cₚ₂(1)Δₖ²,

kₘₐₓ=kₚ+Δₖ,

where

$${Δ}_{k} = \frac{{A}_{p} - {A}_{adj} - {C}_{p 2} ( 1 )}{2 {C}_{p 2} ( 1 )} ,$$

Aₚ and A_{adj} are the peak and the magnitude at the adjacent frequency bin. Aₘₐₓ is the maximum magnitude and kₘₐₓ is the index to the position of the maximum magnitude in the frequency domain—around the selected spectral peak.

Once the maximum peak and its location are found, the spectral magnitude in the frequency bin is determined using the peak magnitude and the two adjacent bins. The magnitudes are determined from a 3^{rd} order polynomial that has been fitted to one side of the spectrum of a pure sinusoid windowed with a Hanning window. The 3^{rd} order polynomial is used because the adjacent bin with a smaller magnitude is more than one frequency bin away from the position of the maximum magnitude in the audio spectrum. The 3^{rd} order fit is highly accurate and represented by the following coefficients Cₚ_{³}=[−2.2088−2.8538−0.9984 0.0606]. In using these coefficients Cₚ_{³}(4) is shifted by Aₘₐₓ, and the position of the maximum magnitude is considered as the origin.

Also the phase is determined at the three frequency bins—the bin with the peak magnitude and the two adjacent bins. The spectral phase of the sinusoidal spectrum varies linearly around the location of the maximum magnitude with a slope of π per bin.

The N point Hanning window is expressed as follows:

$$w ( n ) = 0.5 ( 1 - cos ( \frac{2 π n}{N} ) ) , n = 0 , … , N - 1.$$

The DFT of the Harming window is given by

W(k)=0.5δ(k)−0.25δ(k−1),

where δ(.) denotes the Dirac delta function. It is obvious from the DFT of the Harming window that the phase difference between the two adjacent frequency bins is π. Similarly, this phase relationship holds for other window functions with the following characteristics:

$$w ( 0 ) = 0 , \\ w ( n ) = w ( N - n ) , n = 1 , … , N - 1 , \\ w ( n ) < w ( \frac{N}{2} - n ) , n = 1 , … , \frac{N}{4} - 1.$$

Using this fact, the spectral phase at the three frequency bins is determined. Prior to the determination of the phase at the two adjacent bins the phase at the location of the maximum magnitude is determined from the spectral phase at the two neighboring frequency bins as follows

Pₘₐₓ=Pₚ+(P_{adj}−Pₚ)|Δₖ|,

The spectral phase at the frequency bin with the peak magnitude and the two adjacent bins are then determined as follows

P̅ₚ=Pₘₐₓ−π(kₚ−kₘₐₓ),

P̅₁=Pₘₐₓ−π(kₚ−1−kₘₐₓ),

P̅₂=Pₘₐₓ−π(kₚ+1−kₘₐₓ).

A relative error is determined by comparing the determined values with the spectral values at the three frequency bins:

$$ξ = {\sum }_{m = 1}^{3} \frac{\vert X ( {k}_{m} ) - \overline{X} ( {k}_{m} ) \vert}{\vert X ( {k}_{m} ) \vert} .$$

The relative error is zero for a perfect sinusoid. A predictability is defined as

ρ=max(1−ζ,0)

The tonality index is then defined as

$$τ = {\sum }_{i = 1}^{I} \frac{{ρ}_{i} {E}_{i}}{{E}_{T}}$$

where I is the number of peaks in a critical band, Eᵢ is the energy in three frequency bins around the peak i, and E_{T} is the total energy in the critical band. The tonality index is 1 if all the peaks in a critical band are representing perfect sinusoids. Since the tonality level of some short tones is likely underestimated, the maximum value and the average value of the tonality index are taken in three successive frames for the same critical band.

For the backward masking 3 msec are assumed as the effective duration of masking for all critical bands regardless of the effective duration of gammatone functions. Hence the backward masking threshold is given by:

$${BM}_{i} ( n ) = ( SL ( i ) - {c}_{kn} ) ( \frac{{log}_{10} ( \frac{n}{{n}_{i} - 0.005 {f}_{s}} )}{{log}_{10} ( \frac{{n}_{i} - 1}{{n}_{i} - 0.005 {f}_{s}} )} ) .$$

The sensation level is given by:

$${SL}_{k} ( i ) = 10 {log}_{10} ( \frac{{A}_{k}^{2} ( i ) {G}_{k}^{2}}{{QT}_{k}} )$$

where Aₖ(i) is the magnitude of the i th kernel determined in critical band k, and Gₖ is the peak value of the Fourier transform of the normalized kernel in critical k, and QTₖ is the elevated threshold in quiet for the same critical band.

Since the effective duration of gammatone kernels is less than 200 msec, the absolute threshold of hearing is elevated by 10 dB/decade. The elevated threshold in quiet in critical band k is then given by:

QTₖ=ATₖ+10(log₁₀(200)−log₁₀(dₖ))

where ATₖ is the absolute threshold of hearing in critical band k, and dₖ is the effective duration of the k th kernel defined as the time interval between the points on the temporal envelope of the k th kernel where the amplitude drops by 90%.

The masking threshold in a critical band at any time instance is determined by taking the maximum of the masking threshold caused by the determined kernels in the same critical band and two adjacent bands.

The initial levels for the masking pattern in critical band k are set to QTₖ and three situations for the masking pattern caused by the kernel are considered. When a maskee starts within the effective duration of the masker, the masking threshold is given by:

Mₖ(nᵢ:nᵢ+Lₖ)=max(M(nᵢ:nᵢ+Lₖ),SLₖ(i)−cₖₙ)

where Mₖ is the masking pattern—in dB—in critical band k, nᵢ is the start time index of the i th kernel, Lₖ=dₖfₛ is the effective length of the gammatone function in critical band k.

Other situations are when a maskee starts after the effective duration of the masker, i.e. forward masking, and when the maskee starts before a masker, i.e. backward masking.

The forward masking contributes to the global masking pattern in critical band k as follows:

Mₖ(nᵢLₖ+1:nᵢ+Lₖ+FLₖ)=max(Mₖ(nᵢ+Lₖ+1:nᵢ+Lₖ+FLₖ),FMᵢ).

Similarly, the backward masking contributes to the global masking pattern in critical band k as follows:

Mₖ(nᵢ−0.005fₛ:nᵢ−1)=max(Mₖ(nᵢ−0.005fₛ:nᵢ−1),BMᵢ).

The masking effects caused by any determined kernel in two adjacent critical bands have been considered. A single masker produces an asymmetric linear masking pattern in the Bark domain, with a slope of −27 dB/Bark for the lower frequency side and a level dependent slope for the upper frequency side. The slope for the upper frequency side is given by

$${s}_{u} = - 24 - \frac{230}{f} + 0.2 {L}_{m}$$

where f is the masker frequency and Lₘ is the masker level in dB. This method has been used to calculate the masking effects caused by each spike in the two immediate neighboring critical bands.

In matching pursuit, at each iteration the value and position of the maximum of the cross correlation of the residual signal and each kernel is determined. The kernel with the highest correlation with the residual signal is identified. The maximum value of the cross correlation and its position are determined. Prior to determining the maximum value for each correlation function, the values below the masking threshold are set to zero. In other words, the correlation at any time index is taken into consideration if its sensation level is above the associated masking threshold at that time index,

$$\frac{{A}^{2} ( n ) {G}_{k}^{2}}{{QT}_{k}} > {10}^{( {M}_{k} ( n ) / 10 )} , \\ \vert A ( n ) \vert > \frac{\sqrt{{QT}_{k} {10}^{( {M}_{k} ( n ) / 10 )}}}{{G}_{k}} .$$

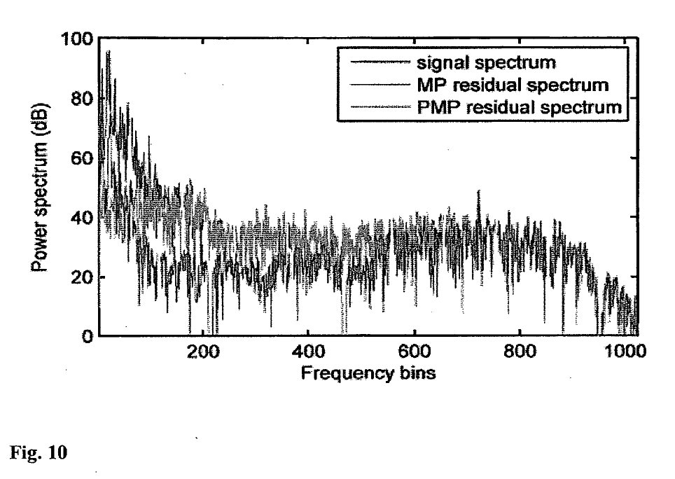

As such, only audible kernels are determined and the masked values in the correlation sequences are discarded. The noise spectrum, i.e. residual spectrum, is shaped and a higher noise level is allowed, as long as it is un-audible. FIG. 10 shows the power spectrum of a frame of an audio signal and also the spectra for the residual for the matching pursuit and the perceptual matching pursuit process. As is seen, the perceptual matching pursuit process shapes the noise spectrum and, therefore, produces higher quality audio signals for the same number of determined kernels. Informal listening tests have also shown the perceptual superiority of the perceptual matching pursuit process over the matching pursuit process.

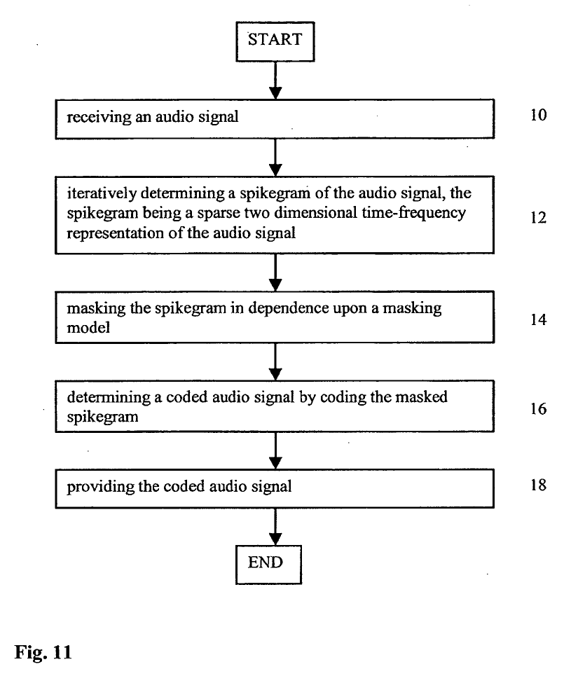

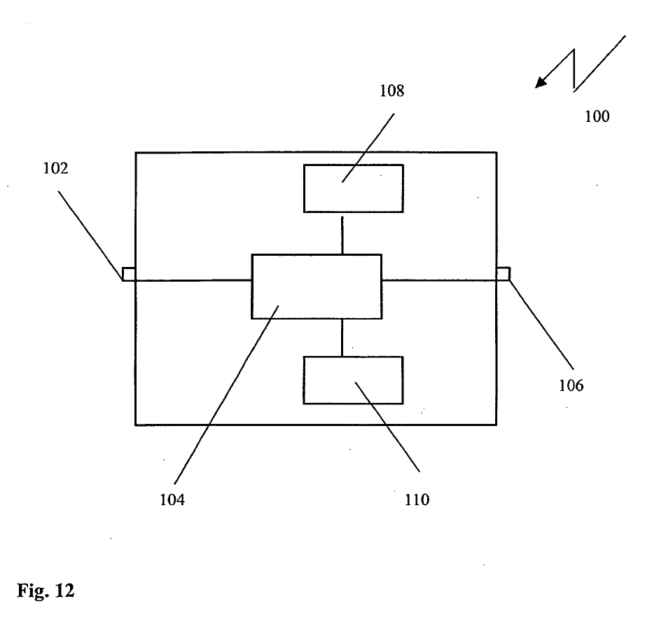

Referring to FIG. 11, a simplified flow diagram of an embodiment of a method of coding an audio signal according to the invention is shown. The embodiment of a method of coding an audio signal is, for example, implemented in an embodiment of an audio coder 100 according to the invention, as illustrated in FIG. 12. At 10, an audio signal is received at input port 102 and provided to electronic circuit 104 for digital signal processing. The electronic circuit 104 iteratively determines a spikegram in dependence upon the audio signal—at 12. The spikegram is a sparse two dimensional time-frequency representation of the audio signal. Using the electronic circuit 104 the spikegram is then—at 14—masked in dependence upon a masking model and—at 16—a coded audio signal is determined by coding the masked spikegram. The coded audio signal is then—at 18—provided to output port 106 for further processing or transmission. The audio coder 100 further comprises memory 108 connected to the electronic circuit 104 for storing data indicative of kernels of a filter bank and memory 110 also connected to the electronic circuit 104 which has stored therein commands for execution on the electronic circuit 104—implemented here, for example, as a processor—when performing the method of coding an audio signal. Optionally, at least a portion of the audio signal processing is performed in a hardware implemented fashion. The audio coder 100 is implemented, for example, on a single chip such as, for example, a Field Programmable Gate Array (FPGA) or System On a Chip (SoC).

The various embodiments of a method of coding an audio signal according to the invention described above are integrated into the embodiment illustrated in FIG. 11 and implemented using, for example, the audio coder illustrated in FIG. 12.

Numerous other embodiments may be envisaged without departing from the spirit or scope of the invention.

What is claimed is:

1. A method comprising:
receiving an audio signal;
iteratively determining a spikegram of the audio signal, the spikegram being a sparse two dimensional time-frequency representation of the audio signal, wherein masking is performed during the determination of the spikegram;
determining a coded audio signal by coding the masked spikegram; and,
providing the coded audio signal.

2. A method as defined in claim 1 comprising decomposing the audio signal into kernels of a filter-bank, the kernels having different center frequencies and different time delays.

3. A method as defined in claim 2 wherein the audio signal is decomposed into kernels of one of a gammatone and a gammachirp filter-bank.

4. A method as defined in claim 2 wherein at each iteration step the audio signal is projected onto the kernels and a spike is determined as a maximum projection.

5. A method as defined in claim 4 wherein each of the kernels comprises a tuning parameter and wherein the tuning parameter is adapted in each iteration step.

6. A method as defined in claim 5 wherein each of the kernels comprises tuning parameters for controlling an instantaneous frequency, an attack slope and a decay slope of the kernel.

7. A method as defined in claim 2 wherein the audio signal is decomposed using a matching pursuit process.

8. A method as defined in claim 2 wherein the spikegram is masked by removing inaudible spikes.

9. A method as defined in claim 8 wherein the spikegram is masked using on-frequency temporal masking.

10. A method as defined in claim 9 wherein the spikegram is masked using off-frequency masking.

11. A method as defined in claim 10 wherein the off-frequency masking comprises determining masking effects caused by each spike in two adjacent critical bands.

12. A method as defined in claim 4 wherein differences between parameters associated with spikes are coded.

13. A method as defined in claim 12 wherein the differences are coded using graph based optimization.

14. A method as defined in claim 13 wherein the masked spikegram is coded using entropy coding.

15. A method as defined in claim 14 wherein an arithmetic coding process is used.

16. A method as defined in claim 15 wherein a differential coding process is used.

17. A method as defined in claim 16 wherein the graph based optimization is performed using one of minimum spanning tree process and traveling salesman problem process.

18. A method as defined in claim 16 wherein the graph based optimization is performed based on the optimization of a global cost function.

19. A method as defined in claim 1 wherein each spike in the spikegram is represented by a quantization vector.

20. A method as defined in claim 19 wherein the quantization vector is determined by a non-linear optimization technique.

21. A method as defined in claim 19 wherein the quantization vector is determined by a linear optimization technique.

22. An audio coder comprising:
an input port for receiving an audio signal;
an electronic circuit connected to the input port for:
iteratively determining a spikegram of the audio signal, the spikegram being a sparse two dimensional time-frequency representation of the audio signal, wherein masking is performed during the determination of the spikegram; and,
determining a coded audio signal by coding the masked spikegram; and,
an output port connected to the electronic circuit for providing the coded audio signal.

23. An audio coder as defined in claim 22 comprising first memory connected to the electronic circuit for storing data indicative of kernels associated with the impulse response of a filter bank.

24. An audio coder as defined in claim 23 comprising second memory connected to the electronic circuit having stored therein commands for execution on the electronic circuit.

25. A storage medium having stored therein executable commands for execution on a processor, the processor when executing the commands performing:
receiving an audio signal;
iteratively determining a spikegram of the audio signal, the spikegram being a sparse two dimensional time-frequency representation of the audio signal, wherein masking is performed during the determination of the spikegram;
determining a coded audio signal by coding the masked spikegram; and,
providing the coded audio signal.

26. A method comprising:
receiving an audio signal;
iteratively determining a spikegram of the audio signal, the spikegram being a sparse two dimensional time-frequency representation of the audio signal by decomposing the audio signal into kernels associated with the impulse response of a filter-bank, the kernels having different center frequencies and different time delays, wherein each of the kernels comprises a tuning parameter and wherein the tuning parameter is adapted in each iteration step;
masking the spikegram in dependence upon a masking model;
determining a coded audio signal by coding the masked spikegram; and,
providing the coded audio signal.

27. A method as defined in claim 26 wherein each of the kernels comprises tuning parameters for controlling an instantaneous frequency, an attack slope and a decay slope of the kernel.

28. A method as defined in claim 6 comprising:
determining a best and a second best matching kernel;
determining the tuning parameter associated with the center frequency in dependence upon the best and second best matching kernel; and,
determining the tuning parameters associated with time delay and amplitude in dependence upon one of the best and second best matching kernel, the one of the best and second best matching kernel being determined in dependence upon information related to the tuning parameter associated with the center frequency.
